(19) United States
(12) Patent Application Publication
(10) Pub. No.: US 2018/0135462 A1
(43) Pub. Date: May 17, 2018

(54) DEVICE FOR UNCOUPLING FIRST AND SECOND PARTS OF A TURBINE ENGINE

(71) Applicant: SAFRAN AIRCRAFT ENGINES, Paris (FR)

(72) Inventor: Fabrice Michel François René Cretin, La Grande Paroisse (FR)

(73) Assignee: SAFRAN AIRCRAFT ENGINES, Paris (FR)

(21) Appl. No.: 15/808,720

(22) Filed: Nov. 9, 2017

(30) Foreign Application Priority Data
Nov. 14, 2016 (FR) 1660946

(51) Int. Cl. F01D 25/16; F16C 43/04; B23P 19/04; B23P 15/00

(52) U.S. Cl. CPC F01D 25/162; F16C 43/04; F05D 2230/70; B23P 15/003; F05D 2220/30; B23P 19/04

(57) ABSTRACT

Device for uncoupling first and second parts of a turbine engine, the parts extending around an axis A, wherein the first part comprises an annular row of axial through-openings that extend around the axis A, and in that the second part comprises an annular row of axial fusible lugs that pass axially through the openings and include threaded portions onto which a nut having the axis A and intended for axially clamping the parts is screwed.

### TECHNICAL FIELD

Embodiments of the present disclosure relate to a device for uncoupling parts of a turbine engine, such as bearing supports of the turbine engine.

### BACKGROUND

A turbine engine includes, from upstream to downstream, in the direction of flow of the gases, a compressor, a combustion chamber and a turbine. The function of the compressor is to increase the pressure of the air supplied to the combustion chamber. The function of the turbine is to ensure that the compressor rotates by taking off some of the pressure energy from the hot gases leaving the combustion chamber and by transforming the pressure energy into mechanical energy.

The compressor and the turbine consist of a first assembly of stationary parts that make up the stator and a second assembly of parts that make up the rotor and are capable of being rotated relative to the stator.

The rotor of the compressor and the rotor of the turbine form an assembly that is rigidly connected by a rotating shaft. The rotation of the rotor relative to the stator is made possible by means of bearings, a bearing being a mechanical member that supports and guides a rotor, in particular the shaft of the rotor. The bearing includes a first part attached to the rotor shaft and a second part attached to the stator via a bearing support. A roller bearing is arranged between the two parts of the bearing, thus allowing one part of the bearing to rotate relative to the other. The roller bearing can be, for example, of the ball bearing type, of the cylindrical roller type or of the conical roller type.

A turbine engine can also be of the “twin-spool” type, which means that it includes two rotors arranged coaxially, a bearing allowing relative rotation between the two rotors.

A turbine engine can also include a fan, which makes up a first stage of the compressor. The fan includes very large blades, referred to as fan blades, one of the effects of which is to increase the mass and inertia of the rotor.

In the event of a fan blade breaking, an imbalance is generated on the shaft supporting the fan. An imbalance is a phenomenon of unbalancing the rotor, the center of gravity of which is no longer precisely on the axis of rotation as it should be. Cyclic loads and strong vibrations are thus communicated, via the bearing support, to the stator of the turbine engine, it being possible for high risks of damage to lead to the self-destruction thereof. In order to avoid the transmission of these undesirable phenomena to the stator, it is necessary to uncouple the bearing support, i.e. stop the mechanical transmission of the rotation, in particular by separating the two parts forming the bearing support.

A solution consisting in using fusible screws for attaching an upstream part and a downstream part that form a bearing support is known. The fusible screws have a portion of a reduced cross section that is capable of breaking beyond a predetermined pulling force and thus of uncoupling the two parts making up the bearing support.

### SUMMARY

Embodiments of the present disclosure propose a device for uncoupling first and second parts of a turbine engine, the parts extending around an axis A, wherein the first part comprises an annular row of axial through-openings that extend around the axis A, and in that the second part comprises an annular row of axial fusible lugs that pass axially through the openings and include threaded portions onto which a nut having the axis A and intended for axially clamping the parts is screwed.

Embodiments of the present disclosure thus propose new uncoupling technology consisting in replacing the fusible screws from the prior art with a fusible lug connection. Moreover, in contrast with the prior art where a nut is mounted on each fusible screw, a nut (preferably a single nut) is in this case screwed onto the fusible lugs and allows the two parts to be attached. Using the device according to the embodiments of the present disclosure, there is therefore a single step of screwing and clamping, which significantly saves time when attaching the parts.

The device according to embodiments of the present disclosure can comprise one or more of the following features, taken independently or in combination:

the first part comprises a radially outer annular wall for axially bearing the second part and including the row of openings;

the annular wall comprises a first radial surface for axially bearing the second part and a second opposite radial surface for axially bearing the nut;

each of the openings is generally elongate in the circumferential direction around the axis A;

the second part comprises a radial surface or wall for axially bearing on the first part, the lugs axially projecting from the radial surface or wall;

each of the lugs comprises a free end portion which carries one of the threaded portions and which is connected by a fusible connection portion to the rest of the second part;

the fusible connection portion comprises a thinning;

the free end portion comprises the threaded portion on its outer periphery;

the lugs are integrally formed with the second part;

the first and second parts are bearing supports of the turbine engine;

a circumference passing through the inner periphery of the nut has a larger diameter than that of a circumference passing through the outer periphery of the bearing of the turbine engine, the bearing support consisting for example of the first part comprising for example a cylindrical wall having the axis A, it being possible for the bearing, for example a roller bearing, to be mounted by also being capable, for example, of being held axially against an inner annular shoulder of the wall by means of a nut screwed onto the inner periphery of the cylindrical wall;

the openings are separated from one another by radial support pillars which are delimited at a first axial end by a radial surface and at a second opposite axial end by a concavely curved surface, the opening of which opens in the axial direction;

a circumference passing through the inner periphery of the openings has a smaller diameter than that of a circumference passing through the inner periphery of the nut;

a circumference passing through the inner periphery of the nut has a smaller diameter than that of a circumference passing through the outer periphery of the openings;

locking means, such as a lock nut or washer, are mounted between the lugs and the nut in order to prevent the nut from loosening unintentionally.

Embodiments of the present disclosure also relate to a turbine engine, comprising at least one device as described herein.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a schematic partial axial section through two turbine engine parts that are interconnected by an uncoupling device according to one or more embodiments of the present disclosure;

FIG. 2 is a schematic partial perspective view of one of the parts from FIG. 1, and shows the fusible lugs of the part;

FIG. 3 is a schematic partial perspective view of the parts from FIG. 1, the fusible lugs of one of the parts passing through the openings in the other part.

### DETAILED DESCRIPTION

The detailed description set forth below in connection with the appended drawing, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

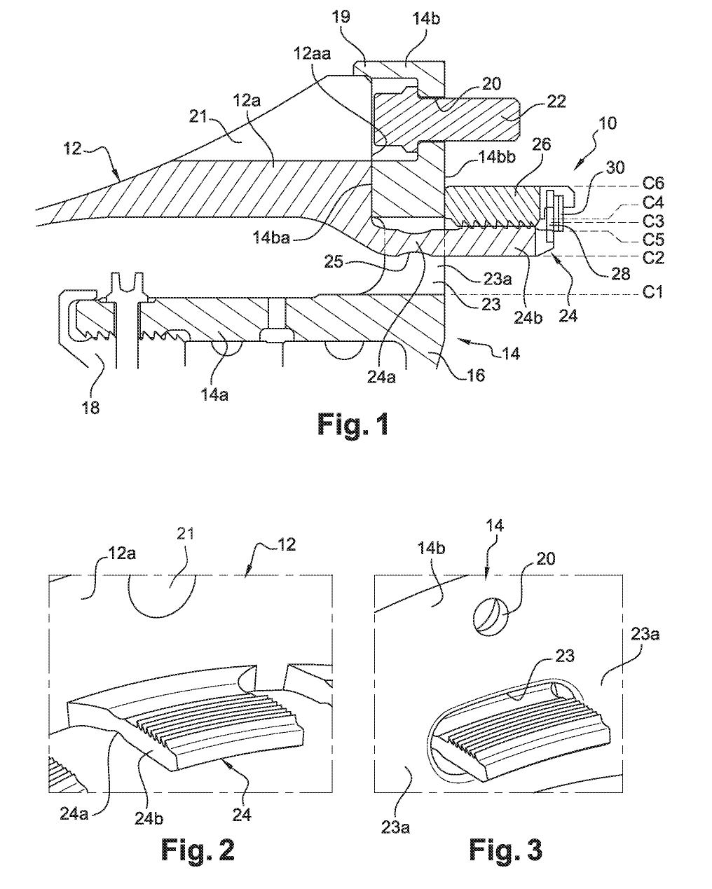

FIG. 1 shows an embodiment of an uncoupling device 10 according to one or more embodiments of the present disclosure. The uncoupling device 10 is suitable for use with, for example, a turbine engine. In the example shown, the device 10 is used to connect two parts, such as two bearing supports 12, 14.

The bearing support 12, located here on the left in the drawing or upstream in relation to the flow of the gases in a turbine engine, can be used to support a roller bearing upstream of a module enclosure of the turbine engine. The bearing support 14, located here on the right or downstream, can be used to support another roller bearing downstream of the aforementioned module. It can also be connected to the stator of the turbine engine.

The bearing support 14 extends around an axis A (not shown) and can have a rotational symmetry about the axis A, which is the longitudinal axis of the turbine engine. The bearing support 14 comprises a cylindrical wall 14a having the axis A and a radial annular wall 14b which extends radially outwards from the downstream axial end of the wall 14a.

The roller bearing can be mounted directly inside the wall 14a and held axially against an inner annular shoulder 16 of the wall by means of a nut 18 screwed onto the inner periphery of the wall 14a.

The wall 14b comprises, on its outer periphery, an annular row of axial through-holes 20 for the passage of screws 22 for attaching the bearing support 14 to a stator part, such as an intermediate case hub of the turbine engine. The wall 14b comprises a downstream radial surface 14bb for axially bearing on a complementary surface of the case hub, and an upstream radial surface 14ba on which the bearing support 12 is intended to bear axially.

On the inner periphery of the wall 14b, at the junction with the wall 14a, the bearing support 14 comprises an annular row of axial through-openings 23. The openings 23 thus open into the surfaces 14ba, 14bb, respectively. At the downstream outlets of the openings 23, the surface 14bb is planar in cross section. In contrast, at the upstream outlets of the openings 23, the surface 14ba is concavely curved in cross section, the opening of which surface is oriented upstream.

Two adjacent openings 23 are separated from one another by a radial support pillar 23a (FIG. 3). In the example shown, the openings are each generally elongate substantially in the circumferential direction. For example, they are oblong or oval.

The bearing support 12 extends around the axis A and can have a rotational symmetry about the axis A. The bearing support 12 comprises a wall 12a that defines, downstream, a radial surface 12aa for bearing on the surface 14ba. The bearing support 12 is centered on the axis A by the outer periphery of its wall 12a engaging with a cylindrical rim 19 extending upstream from the outer periphery of the wall 14b. The wall 12a comprises an annular row of holes 21 aligned axially with the holes 20 in order to mount the screws 22.

The bearing support 12 comprises axial fusible lugs 24 which extend downstream from the inner periphery of the wall 12a. Each lug 24 comprises two portions, an upstream portion 24a and a downstream portion 24b, respectively, the downstream portion 24b of each lug being free. The upstream portion 24a is a fusible portion that comprises a thinning 25. The mechanical strength of this fusible portion 24a is calculated such that the connection between the two bearing supports 12, 14 yields in the portion when the forces passing through the parts exceed a particular threshold, corresponding for example to the event of the loss of a fan blade of the turbine engine.

As can be seen in FIG. 1, the fusible portions 24a of the lugs 24 and the support pillars 23a are located substantially in the same radial plane. The portions 24b of the lugs are threaded at the outer peripheries thereof. In other words, the portions each comprise a smooth radially inner surface and a threaded radially outer surface.

A nut 26, in this case a single nut, is screwed from downstream onto the lugs 24 and bears, by means of its upstream end, on the surface 14bb of the wall 14b. Locking means, such as a lock-nut 28 and a ring 30, are mounted between the downstream ends of the nut 26 and the lugs 24 in order to prevent the nut from loosening accidentally during operation.

The following can be seen in FIG. 1:

a circumference C1 passing through the inner periphery of the openings 23 has a smaller diameter than that of circumferences C2, C3 passing through the inner peripheries and outer peripheries, respectively, of the lugs;

a circumference C4 passing through the outer periphery of the openings 23 has a larger diameter than that of circumferences C2, C3;

a circumference C5 passing through the inner periphery of the nut 26 has a smaller diameter than that of a circumference C4 and a larger diameter than that of a circumference passing through the outer periphery of the aforementioned roller bearing;

a circumference C6 passing through the outer periphery of the nut 26 has a larger diameter than that of the circumference C4.

The bearing supports 12, 14 can be assembled and attached in the following manner. The bearing supports 12, 14 are aligned on the axis A. The bearing support 12 is moved in axial translation towards the bearing support 14 until the lugs 24 pass through the openings 23. The nut 26 is therefore connected downstream of the lugs 24 and screwed thereon until it comes to bear axially on the surface 14bb of the wall 14b of the bearing support 14. The wall 14b is thus axially clamped between the wall 12a of the bearing support 12 and the nut 26. Locking means are then mounted to the downstream ends of the nut 26 and the lugs 24.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A device for uncoupling first and second parts of a turbine engine, said parts extending around an axis A, wherein said first part comprises an annular row of axial through-openings that extend around the axis A, and in that said second part comprises an annular row of axial fusible lugs that pass axially through said openings and include threaded portions onto which a nut having the axis A and intended for axially clamping the parts is screwed.

2. The device according to claim 1, wherein the first part comprises a radially outer annular wall for axially bearing the second part and including said row of openings.

3. The device according to claim 1, wherein each of said openings is generally elongate in the circumferential direction around the axis A.

4. The device according to claim 1, wherein the second part comprises a radial surface or wall for axially bearing on said first part, said lugs axially projecting from said radial surface or wall.

5. The device according to claim 1, wherein each of said lugs comprises a free end portion which carries one of said threaded portions and which is connected by a fusible connection portion to the rest of said second part.

6. The device according to claim 5, wherein said fusible connection portion comprises a thinning.

7. The device according to claim 5, wherein said free end portion comprises said threaded portion on its outer periphery.

8. The device according to claim 1, wherein said lugs are integrally formed with said second part.

9. The device according to claim 1, wherein said first and second parts are bearing supports of said turbine engine.

10. A turbine engine comprising at least one device according to claim 1.
